(19) United States
(12) Patent Application Publication
(10) Pub. No.: US 2014/0285925 A1
(43) Pub. Date: Sep. 25, 2014

(54) DRIVER CIRCUIT

(71) Applicant: TEXAS INSTRUMENTS INCORPORATED, Dallas, TX (US)

(72) Inventors: Rajarshi Mukhopadhyay, Allen, TX (US); Paul Merle Emerson, Murphy, TX (US)

(73) Assignee: Texas Instruments Incorporated, Dallas, TX (US)

(21) Appl. No.: 13/849,102

(22) Filed: Mar. 22, 2013

(51) Int. Cl. G05F 3/02

(52) U.S. Cl. CPC G05F 3/02
USPC 360/123.1; 323/304; 361/139; 318/501

(57) ABSTRACT

A driver circuit includes a first current source configured to sink part of the current from a power supply through a load and a second current source configured to sink part of the current from the power supply to a return path, bypassing the load, so that the current through the load is the difference between the current from the power supply and the current through the second current source.

### BACKGROUND

Power supplies typically cannot respond instantaneously to a large change in load current, and typically, power supply voltage transients occur when load current suddenly changes. The resulting voltage transients may affect waveforms for circuitry driving the load current, or may affect other nearby circuitry that may require a low-noise power supply voltage. Electronic driver circuits for driving relatively large current loads commonly have large capacitors to provide instantaneous energy to the load to reduce power supply voltage transients. However, as circuit sizes become smaller, and as circuits are placed in ever smaller environments, it is not always possible or practical to provide large capacitors locally where they are needed. There is an ongoing need to reduce power supply transients without having to provide large local capacitors.

### BRIEF DESCRIPTION OF THE DRAWINGS

FIG. 1 is a block diagram schematic illustrating an example embodiment of a prior art magnetic head write driver circuit.

FIG. 2 is a waveform illustrating a prior art example of current as a function of time in a magnetic head during writing.

FIGS. 3A-3D are block diagram schematics illustrating a prior art sequence of current source magnitudes during the generation of the current waveform of FIG. 2.

FIG. 4 is a waveform illustrating power supply current for the prior art sequence of current source magnitudes of FIGS. 3A-3D.

FIGS. 5A-5D are block diagram schematics illustrating an example embodiment of an improved sequence of current source magnitudes to generate a current waveform as in FIG. 2.

FIG. 6 is a flow chart of an example embodiment of a method of driving a magnetic head.

### DETAILED DESCRIPTION

One example of a circuit in a physically small environment with no room for large capacitors is in a magnetic disk drive where it would be desirable to mount a head driver circuit on a small magnetic head. In a rotating magnetic disk drive, a magnetic head is attached to a moveable actuator arm and the magnetic head is suspended very dose to a spinning disk. When writing data, a magnetic field from the head penetrates a ferromagnetic material on the surface of the disk. As the disk rotates under the head, sequential reversals in the direction of the magnetic field from the head leave sequential areas on the surface of the disk with opposite directions of magnetization.

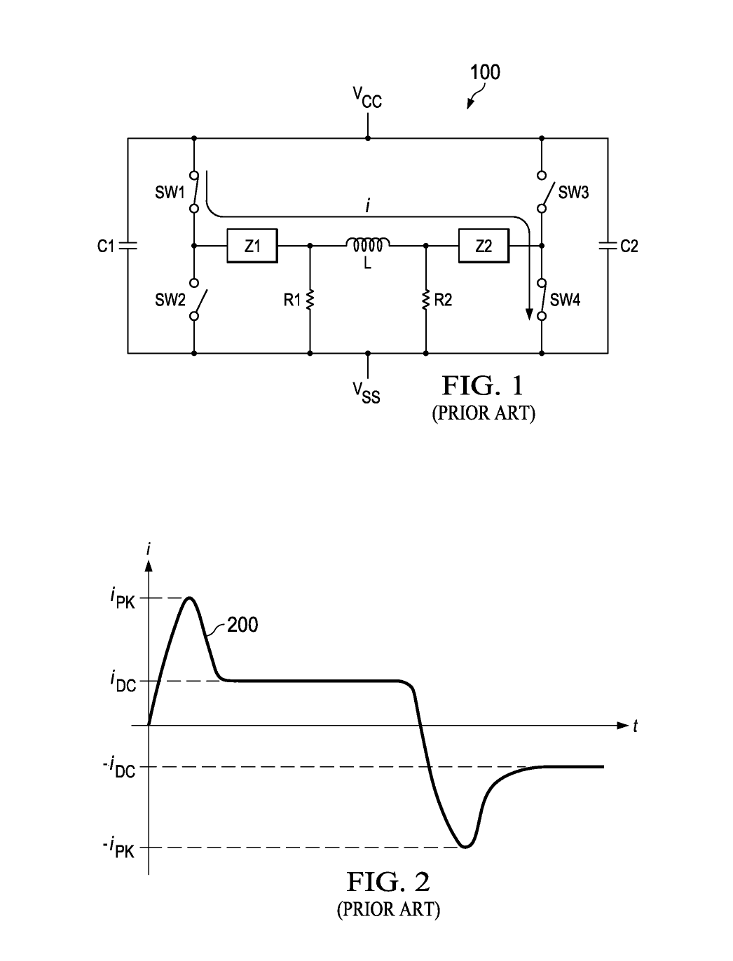

FIG. 1 illustrates a typical write driver circuit 100 (simplified to facilitate illustration and explanation) for driving a magnetic head. As seen by a write driver circuit, the head is an inductive coil L. In the example of FIG. 1, the head (L) is connected in an “H” bridge of four switches (SW1, 5W2, SW3, SW4). As illustrated in FIG. 1, when switches SW1 and SW4 are dosed, and switches SW2 and SW3 are open, current flows through the head in the direction of the arrow labeled “i” in FIG. 1. When switches SW2 and SW3 are closed, and switches SW1 and SW4 are open, current flows through the head in the opposite direction. Typically, a driver circuit containing SW1, SW2, SW3, and SW4 is positioned some distance away from the head. The driver circuit is connected to the head through transmission lines (depicted as impedances Z1 and Z2 in FIG. 1). The transmission lines (Z1, Z2) need impedance matching resistances at the head (L) (depicted as resistors R1 and R2 in FIG. 1) to suppress reflections. In addition, as will be explained further below, large capacitors (C1, C2) are needed to store energy to reduce power supply transients at the driver circuit when current is instantaneously changed.

From the equation relating voltage, current, and inductance (V=L*di/dt), it takes a large voltage across an inductance to cause a large rate-of-change of current. High write data rates require the current in a magnetic head to reverse rapidly. It is common to boost or overdrive the head voltage during a current reversal to accelerate the rate of current change, resulting in a current overshoot, and then the current is reduced to a magnetic flux maintenance level between reversals. FIG. 2 illustrates a typical waveform 200 of current through a magnetic head, The current required to maintain magnetic flux is i_{DC}. The current through the head is switched from i_{DC} to −i_{DC} as rapidly as possible. To accelerate the reversal, the current through the head is overdriven, resulting in a peak current (i_{PK} or −i_{PK}) and then the current magnitude is reduced to the magnetic flux maintenance level (i_{DC} or −i_{DC}). As an example of magnitudes, i_{PK} is typically on the order of 100 mA, and i_{DC} is typically on the order of 40 mA.

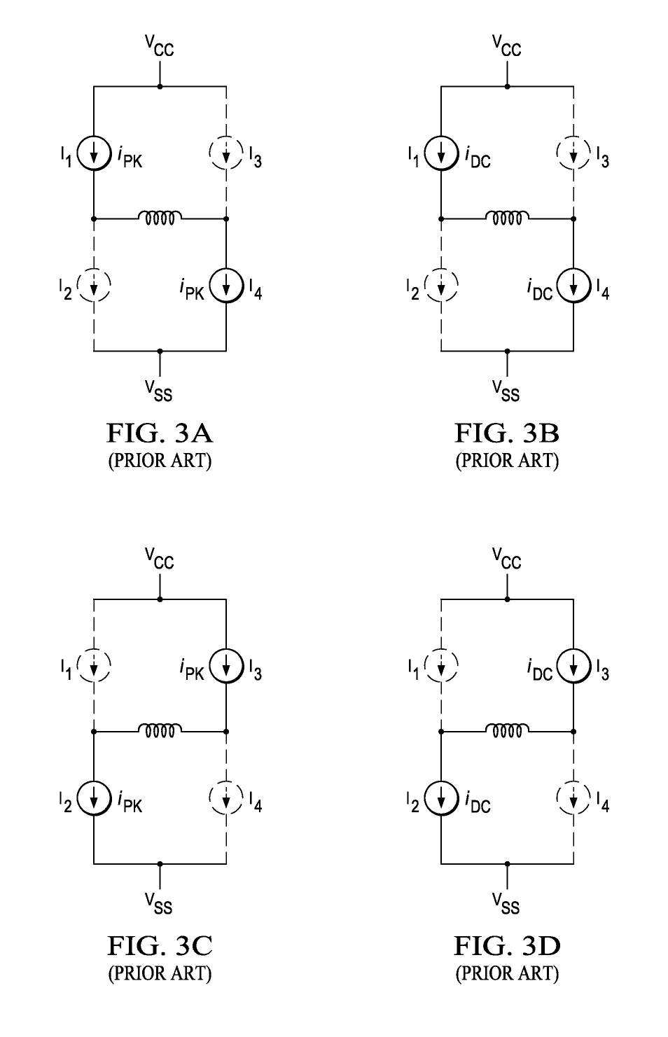

FIGS. 3A-3D depict a sequence of write driver current magnitudes to illustrate how the current waveform of FIG. 2 is typically generated. In FIG. 3A, current sources I1 and I4 drive the head to a peak current i_{PK}. In FIG. 3B, current sources I1 and I4 then drive the head to a magnetic flux maintenance level i_{DC}. In FIG. 3C, current sources I2 and I3 reverse the current in the head to a peak current −i_{PK}. In FIG. 3D, current sources I2 and I3 then drive the head to the magnetic flux maintenance level i_{DC}. In the circuit depicted in FIGS. 3A-3D, there are four current sources. As an alternative, the current sources connected to one of the power supply terminals may be just switches. For example, current sources I1 and I3 may be just switches, or current sources I2 and I4 may be just switches.

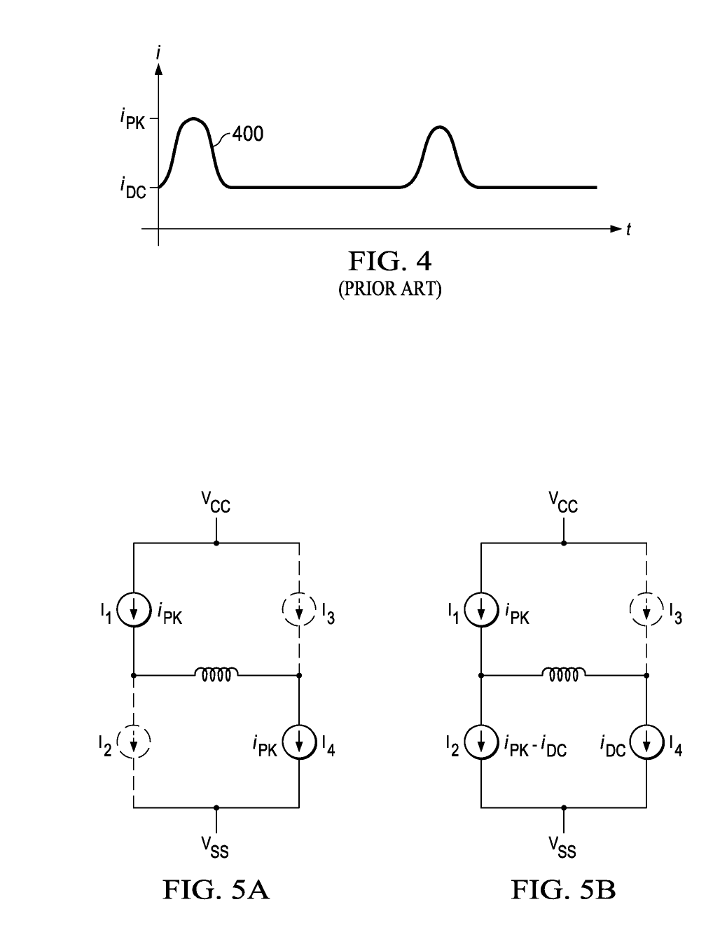

FIG. 4 illustrates power supply current 400. Referring again to FIG. 1, each change of current level (from i_{PK} to i_{DC}, from i_{DC} from to −i_{PK}, from −i_{PK} to −i_{DC}, and from −i_{DC} to i_{PK}) through the head results in a change in current from the power supply. In FIG. 4, the power supply provides a current i_{PS} at a level of i_{DC} required to maintain magnetic flux, with occasional peaks to a level of i_{PK}. Each transition from i_{DC} to i_{PK} and from i_{PK} to i_{DC} may result in a voltage transient on the power supply voltage. Any resulting voltage transients can affect the timing and magnitude of the current changes, which in turn can affect the signal-to-noise ratio. In addition, a noisy power supply voltage may cause significant radio frequency interference (RFI) or may degrade the performance of other circuitry connected to the power supply. Accordingly, as illustrated in FIG. 1, large power supply capacitors (C1 and C2) are typically needed to reduce power supply voltage transients at the write driver circuit.

There are multiple changes to the configuration of FIG. 1 that would be desirable. First, it would be desirable to mount the write driver circuit directly on the magnetic head to eliminate the transmission lines (Z1, Z2) and the impedance matching resistances (R1, R2), and therefore eliminate the voltage drop and power loss in the transmission lines and eliminate the power loss in the impedance matching resistances, Second, an industry trend for many integrated circuits is to reduce the power supply voltage to save power, so it would be desirable to reduce the power supply voltage for the head driver circuit. However, if the power supply voltage is reduced, then controlling voltage transients at the write driver circuit becomes even more critical. However, magnetic heads are physically small, and if the write driver circuit is mounted directly on the magnetic head, there may not be room for large power supply capacitors. Accordingly, there is a need to reduce the changes in current from the power supply so that large power supply capacitors are not needed locally at the write driver circuit.

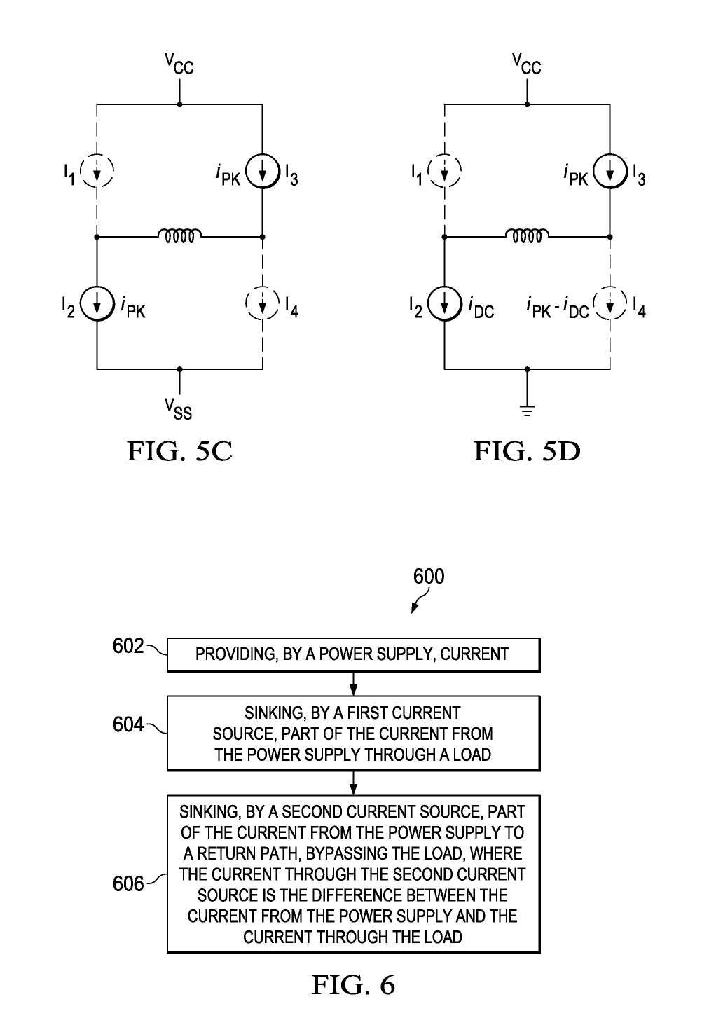

FIGS. 5A-5D depict a sequence of write driver current magnitudes during which the current from the power supply is essentially constant, despite rapidly changing currents through the head (L). In FIG. 5A, current sources I1 and I4 drive the head to a peak current i_{PK}. In FIG. 5B, current source I1 continues to generate a current of i_{PK}, but instead of all the current going through the head (L), current source I2 diverts current having a magnitude of i_{PK}-i_{DC} to a power supply return path, bypassing the head (L), and current source I4 generates a current of i_{DC} through the head (L). As a result, the current from the power supply is i_{PK}, but the current through the head (L) is i_{DC}. In FIG. 5C, current sources I2 and I3 reverse the current in the head to a peak current −i_{PK}. In FIG. 5D, current source I3 continues to generate a current of i_{PK}, but instead of ail the current going through the head (L), current source I4 diverts current having a magnitude of i_{PK}-i_{DC}, and current source I2 generates a current of i_{DC} through the head (L). As a result, the current from the power supply for each of FIGS. 5A-5D is a constant i_{PK}, but the current through the head (L) varies as depicted in FIG. 2. Since the current from the power supply is constant, there is no need for large power supply capacitors locally at the write driver circuit.

In the circuit depicted in FIGS. 5A-5D, there are four current sources. As an alternative, the current sources connected to one of the power supply terminals may be just switches. For example, For example, current sources I1 and I3 may be just switches, or current sources I2 and I4 may be just switches.

While the above example is for a magnetic head, the method applies equally to other types of power supply loads where bi-directional current is needed by the load. For example, electric motors and magnetic actuators may also require bi-directional current, inductive motors and magnetic actuators may also need to boost the initial voltage to accelerate motion and then reduce the current to a steady-state level. A driver sequence as in FIGS. 5A-5D may also be used to bi-directionally drive an electronic motor circuit or a magnetic actuator with constant power supply current but varying current through the load.

FIG. 6 illustrates a method 600 for driving a load, whether a magnetic head or other load such as a motor. At step 602, a power supply provides current. Note that the current from the power supply may be through a current source or a switch. At step 604, a first current source sinks part of the current from the power supply through a load. At step 606, a second current source sinks part of the current from the power supply to a return path, bypassing the load, where the current through the second current source has a magnitude of the difference between the current from the power supply and the current through the load.

While illustrative and presently preferred embodiments of the invention have been described in detail herein, it is to be understood that the inventive concepts may otherwise variously embodied and employed and that the appended claims are intended to be construed to include such variations except insofar as limited by the prior art.

What is claimed is:

1. A driver circuit, comprising:
a first current source configured to sink at least part of the current from a power supply through a load to a return path; and
a second current source configured to sink at least part of the current from the power supply to the return path, bypassing the load, so that the current through the load is the difference between the current from the power supply and the current through the second current source.

2. The driver circuit of claim 1, where the current from the power supply is substantially constant while the current through the load varies.

3. The driver circuit of claim 1, where there are no bypass capacitors from the power supply to the return path, local to the driver circuit.

4. The driver circuit of claim 1, where the load is a magnetic head for a disk drive.

5. The driver circuit of claim 4, where the current from the power supply is a peak current level.

6. The driver circuit of claim 4, where the current through the magnetic head is a magnetic flux maintenance level.

7. The driver circuit of claim 1, where the load is an electric motor.

8. The driver circuit of claim 1, where the load is a magnetic actuator.

9. A method, comprising;
providing, by a power supply, current;
sinking, by a first current source, part of the current from the power supply through a load;
sinking, by a second current source, part of the current from the power supply to a return path, bypassing the load, where the current through the second current source is the difference between the current from the power supply and the current through the load.

10. The method of claim 9, further comprising:
sinking, by the first current source, all of the current from the power supply through the load, thereby changing the current through the load without changing the current from the power supply.

11. A driver circuit, comprising;
a first current source, sinking current from a power supply through a load;
a second current source, in parallel with the load and the first current source; and
the first and second current sources controlled so that when the first current source varies the current through the load, the second current source varies the current through the second current source to keep the total current from the power supply constant.

12. The driver circuit of claim 11, where there are no bypass capacitors, from a power supply to a return path, local to the driver circuit.

13. The driver circuit of claim 11, where the load is a magnetic head.

14. The driver circuit of claim 13, where the current from the power supply is a peak current level.

15. The driver circuit of claim 13, Where the current through the head varies between the peak current level and a magnetic flux maintenance level.

16. The driver circuit of claim 11, where the load is an electric motor.

17. The driver circuit of claim 11, where the toad is a magnetic actuator.
